(19) United States
(12) Patent Application Publication
(10) Pub. No.: US 2016/0309957 A1
(43) Pub. Date: Oct. 27, 2016

(54) HYBRID GRIDDLE

(71) Applicants: Philip Bart, Pembroke Pines, FL (US); Robert Bart, Cooper City, FL (US); Edwin Aguilera, Weston, FL (US)

(72) Inventors: Philip Bart, Pembroke Pines, FL (US); Robert Bart, Cooper City, FL (US); Edwin Aguilera, Weston, FL (US)

(21) Appl. No.: 15/136,750

(22) Filed: Apr. 22, 2016

Related U.S. Application Data
(60) Provisional application No. 62/151,042, filed on Apr. 22, 2015.

(51) Int. Cl. A47J 37/06

(52) U.S. Cl. CPC A47J 37/0611

(57) ABSTRACT

A hybrid griddle for cooking batter-based foods has two griddles capable of being folded together in order to cook batter placed between them. The hybrid griddle has a first griddle plate having a first handle and a second griddle plate having a second handle. The two griddle plates are pivotally attached to each other by a hinge so that they may be opened to receive raw batter and to remove a cooked food item, and may be closed to cook batter placed within it. One of the griddle plates has one or more depressions. The depressions may have patterns embossed within them. Interchangeable inserts may be removably placed within the depressions to create patterns in batter cooked on the hybrid griddle.

### CROSS-REFERENCE TO RELATED APPLICATIONS

This application claims priority to U.S. Provisional Application Ser. No. 62/151,042 filed on Apr. 22, 2015, the contents of which are hereby incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable.

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable.

### BACKGROUND OF THE INVENTION

1. Field of Endeavor

The present invention relates to devices and methods for cooking batter based foods. More particularly, the invention relates to a pan or griddle designed to prepare from batter a product that includes features of both pancakes and waffles.

2. Background Information

The concept of a waffle iron having a pair of plates pivotally connected to each other is generally well known. Batter is poured onto one plate and the second plate is folded over on top of the first plate. The plates are then heated, either by integral heating mechanisms or by exposing the waffle iron to a heating element. The heated plates of a conventional waffle iron are heated such that the batter placed between the plates is cooked and becomes solid. Conventional waffle irons generally produce rounded or rectangular shaped waffles that are removed from the heating plates for consumption. Such conventional waffles have generally flat upper and lower surfaces with an array of wells for receiving syrup or other condiments. Conventional waffles irons are often designed to created grooves in the waffles to facilitate separation into smaller waffles. Waffle irons have also been designed to produce waffles in a variety of different shapes and patterns.

Pancakes are generally cooked using batter similar to or the same as the batter used for waffles. However, pancakes are usually heated on an open griddle. When one side is cooked, the pancake is flipped so that the other side is also cooked. Flipping a pancake can be difficult, especially to a novice. As a result, pancakes can be ruined by an improper flip.

Pancake griddles have been designed that include a second griddle opposite the first griddle, but generally they are spaced far enough away that it does not touch a pancake on the first griddle. An operator may then flip the entire device. This usually provides consistently good pancakes for even the very inexperienced cook.

### BRIEF SUMMARY OF THE INVENTION

Accordingly, the primary object of the present invention is to provide an apparatus and method for preparing a food product having different designs on different sides. In addition, it is an object of the invention to provide a food product that is a waffle on one side in a pancake on the other.

In greater detail, a hybrid griddle comprising a first griddle plate having a planar surface and a first handle, a second griddle plate having one or more waffle pans and a second handle wherein the first griddle plate and the second griddle plate are pivotally attached to each other.

In one embodiment, the hybrid griddle has three waffle pans, each having rectangular bosses arranged in a grid pattern. The first griddle plate and the second griddle plate both have a triangular shape.

In another embodiment, the hybrid griddle includes an outer lip and two handles. A handle extends from each of the griddle plates and the handles may be latched together to secure the device and a closed position. The first griddle plate, having a planar surface has a lip extending along its periphery. It is shaped such that when the first griddle plate and second griddle plate are folded flush with each other, the lip substantially surrounds the peripheral edge of the second griddle plate.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a hybrid griddle in accordance with the principles of the invention;

FIG. 2 is another perspective view of a hybrid griddle in accordance with the principles of the invention;

FIG. 3 is a top plan view of a planar griddle plate of a hybrid griddle in accordance with the principles of the invention;

FIG. 4 is a top plan view of a waffle griddle plate of a hybrid griddle in accordance with the principles of the invention;

FIG. 5 is a bottom view of a waffle griddle plate of a hybrid griddle in accordance with the principles of the invention;

FIG. 6 is a perspective view of a hinge of a hybrid griddle in accordance with the principles of the invention;

FIG. 7 is a side view of a hybrid griddle in a closed position in accordance with the principles of the invention;

FIG. 8 is a side view of a handle of a hybrid griddle in the closed position in accordance with the principles of the invention;

FIG. 9 is a top plan view of a handle of a hybrid griddle in the closed position in accordance with principles of the invention;

FIG. 10 is a top plan view of an alternative embodiment of a hybrid griddle in the open position in accordance with the principles of the invention;

FIG. 11 is a side elevation view of a printle and gudgeon of a hinge of the alternative embodiment of a hybrid griddle in accordance with principles of the invention;

FIG. 12 is a top plan view of a hinge of the alternative embodiment of a hybrid griddle accordance with the principles of the invention;

FIG. 13 is a side elevation view of the modified griddle plate of the alternative embodiments of a hybrid griddle in accordance with the principles of the invention;

FIG. 14 is a top plan view of an alternative embodiment of an insert in accordance with the principles of the invention;

FIG. 15 is a top plan view of an alternative embodiment of an insert in accordance with the principles of the invention;

FIG. 16 is a top plan view of an alternative embodiment of an insert in accordance with the principles of the invention;

FIG. 17 is a top plan view of an alternative embodiment of an insert in accordance with the principles of the invention;

FIG. 18 is a top plan view of an alternative embodiment of an insert in accordance with principles of the invention;

FIG. 19 is a top plan view of an alternative embodiment of an insert in accordance with the principles of the invention;

FIG. 20 is a cross-sectional side elevation view of an alternative embodiment of a hybrid griddle in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed is a hybrid griddle for cooking batter-based foods having two griddles capable of being folded together to cook batter placed between them. A hybrid griddle in accordance with the principles of the invention may have a first griddle plate having a planar surface and a first handle, a second griddle plate having one or more waffle depressions in the cooking surface and a second handle. The two griddle plates are pivotally attached to each other so that they may be opened to receive raw batter and to remove a cooked food item, and may be closed to cook batter placed within it.

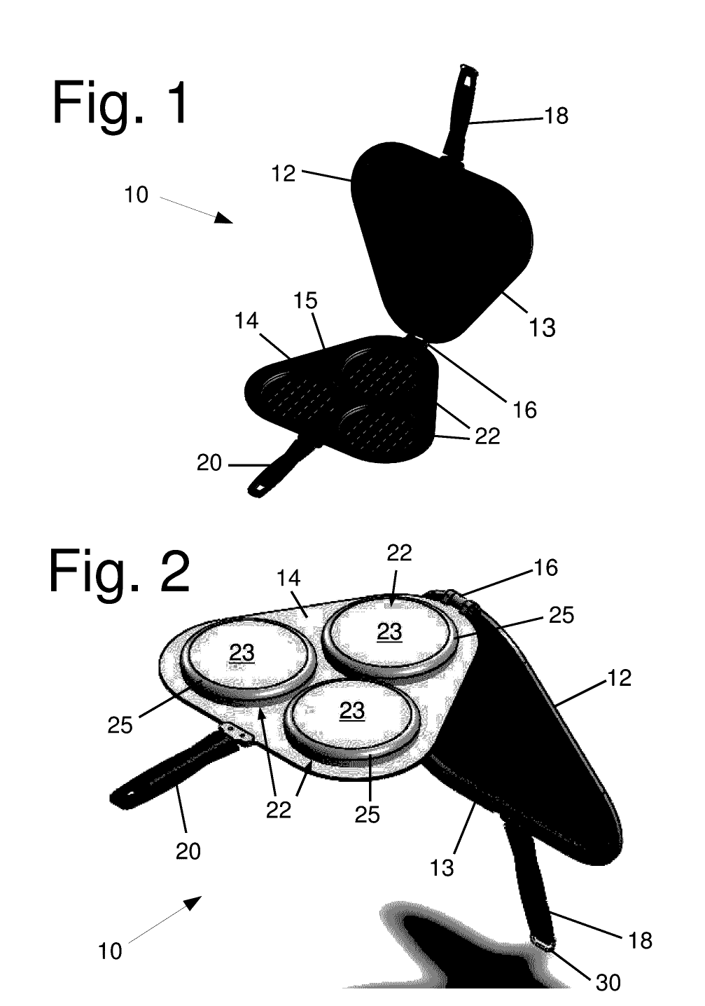

FIGS. 1 and 2 show a hybrid griddle 10 in accordance with the principles of the invention. Hybrid griddle 10 may be comprised of two griddle plates 12 and 14. Plate 12 may be substantially flat and have a planar cooking surface 13. Cooking surface 13 may be of any suitable griddle material such as cast-iron, aluminum, stainless steel, and the like, and may optionally include a nonstick surface such as for example, Teflon. In this embodiment, griddle plate 12 may be substantially triangular and may have a handle 18. Griddle plate 12 may be pivotally attached to griddle plate 14 by hinge 16.

Griddle plate 14 may have a planar surface 15 that may be designed to lie flush against the cooking surface 13 of the griddle plate 12. Griddle plate 14 may also include one or more waffle depressions 22 in the planar surface 15. Waffle depressions 22 may include a grid-like pattern of bosses or studs in order to impart a waffle appearance to batter cooked within the hybrid griddle 10. Griddle plate 14 may have a handle 20 that may correspond to handle 18 of griddle plate 12. A clip 30 may be pivotally attached to handle 18, may be used to fasten handles 18 and 20 together, thereby holding griddle plates 12 and 14 flush against each other.

In this embodiment, the planar surface 15 has three waffle depressions 22. Each of the waffle depressions 22 may be slightly recessed from the planar surface 15. The waffle depressions 22 may have a floor 23 and a side wall 25. In this embodiment, the sidewalls 25, are substantially cylindrical and the floors 23 are substantially circular. Optionally, the waffle depressions may be of any desired configuration such as square, triangular, hexagonal, the shapes of states, stars, hearts, or any other desirable shape. The floors 23 may be comprised of the same material as the cooking surface 13. Optionally, the sidewalls 25 may also be composed of a like material.

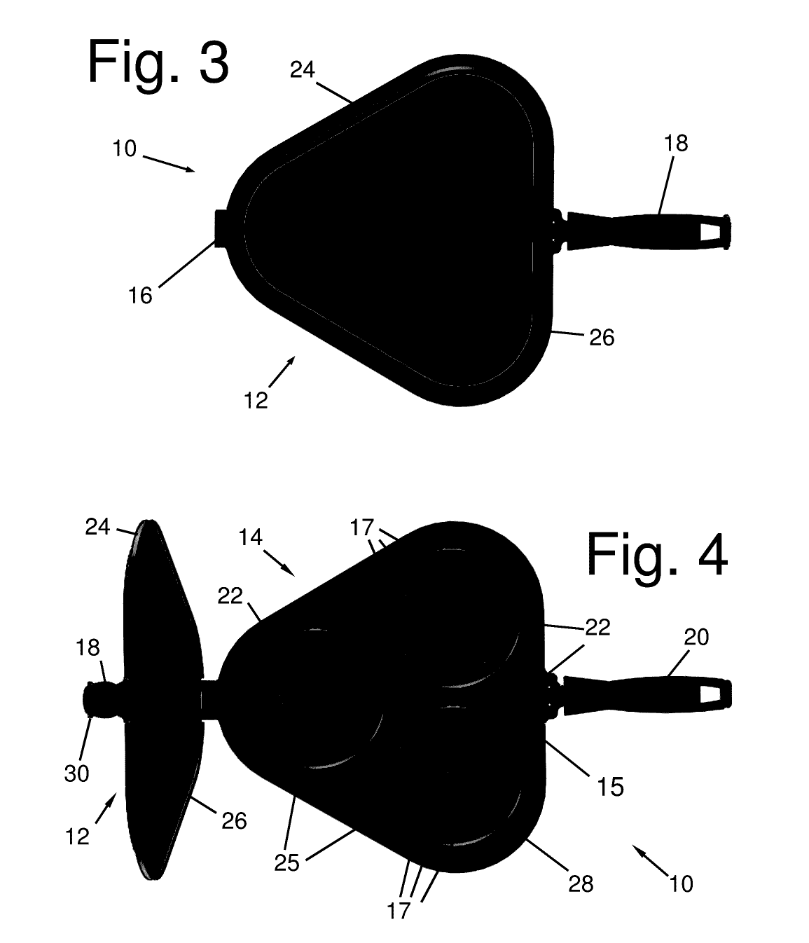

FIG. 3 shows the griddle plate 12 in greater detail. About the periphery of triangular cooking surface 13 may be a raised outer lip 24 protruding from the cooking surface 13. The griddle plate 12 may also include a shoulder 26. The outer lip 24 may assist in aligning the cooking plates 12 and 14, and in holding them stationary relative to one another when they are folded together. Shoulder 26 may also facilitate secure and stationary alignment between the griddle plates 12 and 14.

FIG. 4 shows the griddle plate 14 in greater detail. The griddle plate 14 may have a planar surface 15 that may be substantially rectangular and may have an outer edge 28 that may be substantially congruent with the shoulder 26 of the griddle plate 12. Outer edge 28 may be of dimensions that allow it to fit snugly inside the outer lip 24 of the griddle plate 12.

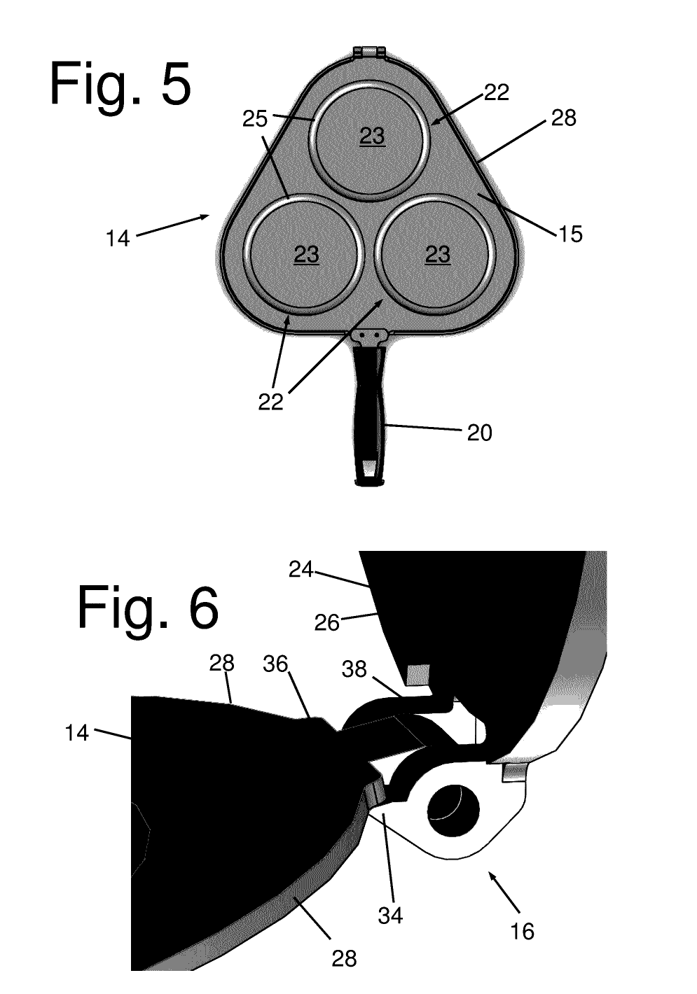

FIG. 5 shows the exterior or bottom of the griddle plate 14. The floors 23 of the waffle depressions 22 may be substantially planar and parallel to one another. The sidewalls 25 of the waffle depressions 22 may be cylindrical, or may be frustoconical, i.e. having a taper.

FIG. 6 shows an enlarged view of the area around the hinge 16. The hinge 16 may include a cam 34 that may impinge upon the exterior of a tab 36 on the griddle plate 14 when the griddle plates 12 and 14 are perpendicular to one another. Optionally, a hinge 16 may be designed such that the cam 34 impinges upon the exterior of the tabs 36 when the plates 12 and 14 are at a different angle, such as for example, an obtuse angle, for example 135°. The hinge 16 may also include a flat region 38 that may lie flush with the outer edge 28 of the tab 36 when the hybrid griddle 10 is in the closed position. This may further stabilize the hybrid griddle 10 when it is in the closed position.

Each waffle depression 22 may include a plurality of bosses 17 similar to those commonly found on the cooking plates of a common waffle iron. In this embodiment, the bosses 17 may be trapezoidal, i.e. having a rectangular shape and tapering along its height. In this embodiment, the bosses 17 are arranged in parallel and perpendicular rows about the floor 23 of the waffle depressions 22. Those skilled in the art of waffle irons will appreciate that a variety of different boss shapes and patterns may be employed when arranging bosses about a griddle of a waffle iron. Any suitable waffle iron pattern may be suitable for use with the invention.

When the griddle plates 12 and 14 have been pivoted about hinge 16 such that they lie flush with one another, the outer edge 28 of the planar surface 15 of the griddle plate 14 may be substantially flush with the inside of the outer lip 24 of the griddle plate 12. The planar surface 15 of the griddle plate 14 may about the shoulder 26 of the griddle plate 12 when the plates are placed flush to one another. Similarly, the handles 18 and 20 may lie flush against one another such that the clip 30 may pivot over handle 20 to secure the hybrid griddle 10 in a closed position.

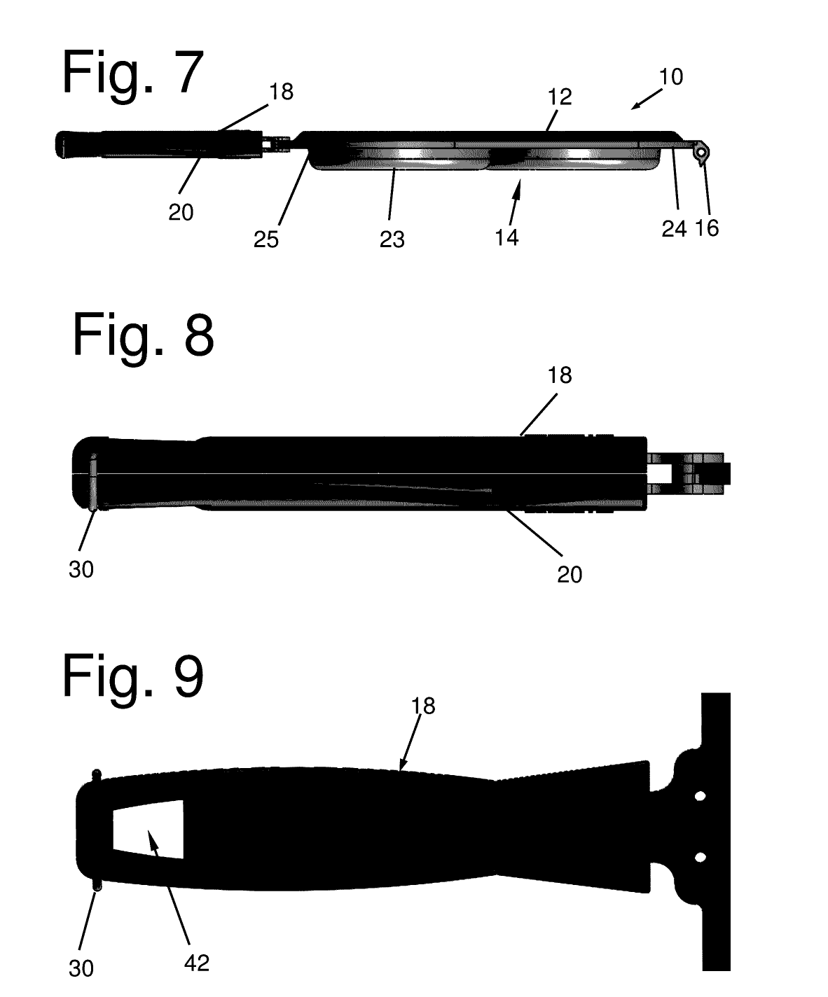

FIG. 7 shows a side view of a hybrid griddle 10. When in the closed position, the planar surface 15 may not be seen from the side because it is substantially flush with the planar griddle plate 12, and is hidden by the outer lip 24 of griddle plate 12.

FIGS. 8 and 9 show enlarged side views of the handles 18 and 20. When the hybrid griddle is in the closed position, the handles 18 and 20 may lie substantially flush to one another. The clip 30 which may be pivotally attached to the handle 18 and may be rotated over the handle 20. By latching handles 18 and 20 together by means of clip 30, an operator may secure the hybrid griddle 10 in the closed position. The handles 18 and 20 may optionally include a whole 42 that may be desirable in order to hang the waffle iron from a hook or similar object.

In order to prepare a hybrid waffle pancake, an operator may deposit batter into one or more of the waffle depressions 22. An operator may then close the hybrid griddle such that the two plates 12 and 14 lie flush with each other. An operator may then place the hybrid griddle onto a stovetop, fire, heating element or the like with the griddle plate 14 beneath the planar griddle plate 12. After sufficient time has been allowed for the batter about the bosses 17 to cook and solidify, the hybrid griddle may be flipped 180° in order to cook the batter from the opposite direction. When the batter is cooked, the resulting food item may have the shape of a waffle on one side in the shape of a pancake on the other side. Optionally, the hybrid griddle may be heated on the flat, planar side first, and may then be flipped to cook the batter from the waffle side.

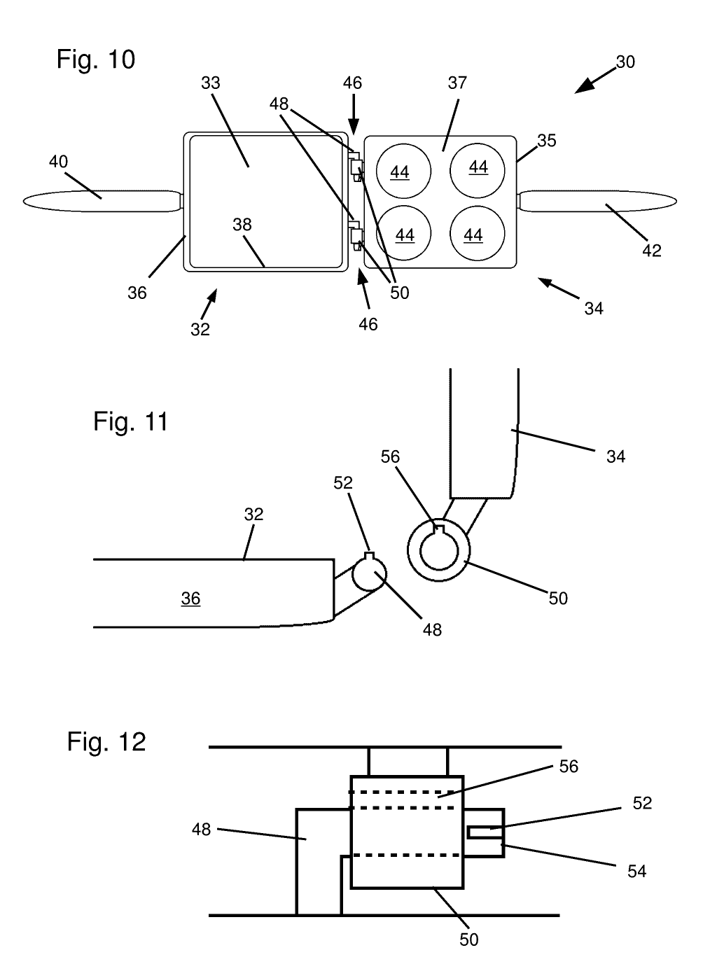

FIG. 10 shows an alternative embodiment of a hybrid griddle 30 in accordance with the principles of the invention. In this embodiment, a planar griddle plate 32 and a modified griddle plate 34 are both rectangular and complementary to each other. The planar griddle plate 32 includes a planar grilling surface 33 and an upward protruding lip 36 along its periphery having an interior wall 38. When the planar griddle plate 32 and the modified griddle plate 34 are folded into a closed position where the planar grilling surface 33 of the plate 32 and modified surface 37 of the plate 34 lie flush against each other, the lip 36 surrounds and covers the periphery 35 of the modified griddle plate 34 as explained above. Complementary handle halves 40 and 42 also lie flush against each other when the griddle plates 32 and 34 are folded on flush with each other as shown in the previous drawings. The alternative embodiment of a hybrid griddle 30 functions in substantially the same manner as the hybrid griddle shown in FIGS. 1-9. The modified griddle plate 32 includes four depressions 44 that do not have a relief or three-dimensional pattern. In this embodiments, the depressions 44 are circular. Optionally, the depressions 44 may have other shapes such as square, hexagonal or even soy oh configurations. The primary differences between the embodiment shown in FIGS. 1-9 and the alternative embodiment 30 are its rectangular shape, its depressions 44, and its dislocating hinges 46. The dislocating hinges 46 are formed by two pintles 48 and two corresponding gudgeons 50 as illustrated in more detail below.

FIGS. 11 and 12 shows a dislocating hinges 46 in more detail. Each of the pintles 48 includes a key 52 positioned at its distal end 54 and configured to fit through keyways 56 of the gudgeons 50. The dislocating hinge 46 can be dislocated only when the key 52 and the keyway 56 are aligned. When the key 52 and the keyway 56 are not aligned, the key 52 prevents the pintle 48 from sliding outs of the gudgeon 50. FIG. 11 shows the pintle 48 and the gudgeon 50 separated from one another. FIG. 12 shows the pintle 48 within the gudgeon 50, thereby forming a hinge 46. In this figure, the key 52 is out of alignment with the keyway 56, thereby preventing dislocation of the hinge 46.

In this embodiment, the keys 52 and keyways 56 align when the plates 32 and 34 are approximately perpendicular. Optionally, the keys 52 and keyways 56 may align when the plates 32 and 34 are at an obtuse or acute angle. Preferably, alignments of the keys 52 and keyways 56 align when the angle between the plates 32 and 34 is between 90° and 180°. This may prevent accidental dislocation of the hinges 46 during normal use. Because the plates 32 and 34 may be disengaged, each may be used independently as well as together.

Optionally, other dislocating hinge mechanisms may be used in place of the pintle and gudgeon design shown in FIGS. 10-12. A skilled artisan will appreciate that there are a variety of mechanisms used to provide a hinge that may be dislocated in order to separate two objects connected by the hand. For example, spring biased latches, bayonet locks and the like may be used to allow attachment and detachment of the plates 32 and 34.

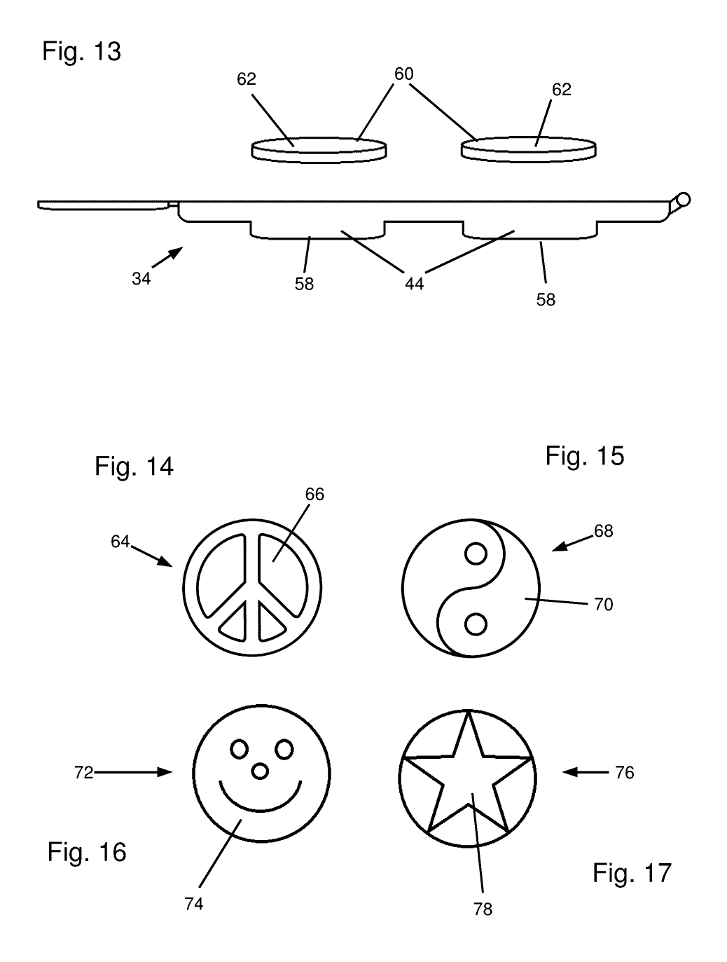

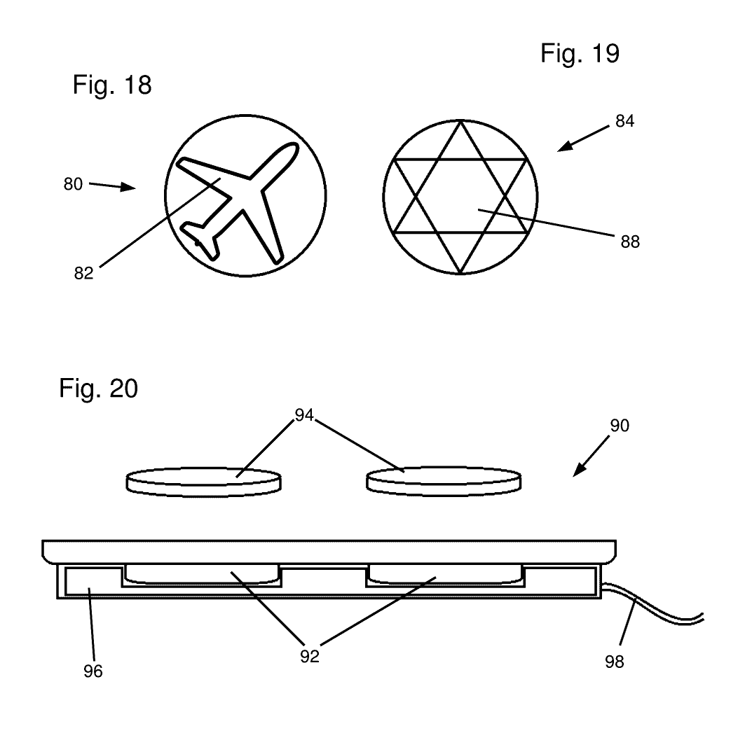

FIG. 13 shows a side view of the modified griddle plate 34 and a pair of circular inserts 60 configured to fit within the depressions 44 and completely cover the floors 58 of the depressions 44. The circular inserts 60 may be embossed with a variety of patterns that children and adults may find amusing, enjoyable and/or aesthetically pleasing. FIGS. 14-18 provide examples of inserts having patterns that may be embossed on an upper surfaces 62 of an insert 60. FIG. 14 shows an insert 64 having an upper surface 66 embossed with a peace sign. FIG. 15 shows an insert 68 having an upper surface 70 embossed with a yen-yang symbol. FIG. 16 shows an insert 72 having an upper surface 74 having a smiley face design embossed on it. FIG. 17 shows an insert 76 that has an upper surface 78 with an embossed star pattern. FIG. 18 shows an insert 80 having an upper surface 82 with an airplane design embossed. FIG. 19 shows an insert 84 having a Star of David design embossed upon it. Inserts 64, 68, 72, 76, 80 and 84 are interchangeable and may all be removably placed within the depressions 44 in order to create one or more pancake/waffle hybrid food products having a desirable configuration.

The hybrid griddle shown in the drawings, may be suitable for use with a separate heating element. Optionally, the hybrid griddle may include one or more internal heating elements such that it may operate as a stand-alone kitchen countertop device. The device may optionally include one or more waffle depressions. The griddle plates may optionally have a circular, rectangular, or other shape. FIG. 20 shows an alternative embodiment of a modified griddle 90 having to depressions 92 into which inserts 94 may be placed, thereby allowing a variety of patterns to be formed in batter cooked upon the modified griddle 90. The modified griddle 90 includes internal heating elements 96 that may be supplied power from an external power source via power cord 98.

The inserts for use in the alternative embodiments 30 and 90 in accordance with the principles of the invention may optionally be sized such that their upper surfaces lie flush with the modified surface 37 of the hybrid griddles 30 and 90. Certain features of a hybrid griddle are shown in some embodiments, but not in others. This is not intended to limit the invention. For example, the hybrid griddle of FIG. 1 could have a detachable hinge, and the griddle shown in FIG. 10 could have two, three, five or other numbers of depressions.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A hybrid griddle comprising:
a first griddle plate having a planar surface and a first handle;
a second griddle plate having one or more waffle depressions and a second handle;
wherein the first griddle plate and the second griddle plate are pivotally attached to each other.
